(19) United States
(12) Patent Application Publication
(10) Pub. No.: US 2015/0039734 A1
(43) Pub. Date: Feb. 5, 2015

(54) METHODS, SYSTEMS, AND COMPUTER READABLE MEDIA FOR ENABLING REAL-TIME GUARANTEES IN PUBLISH-SUBSCRIBE MIDDLEWARE USING DYNAMICALLY RECONFIGURABLE NETWORKS

(71) Applicant: The Trustees of the University of Pennsylvania, Philadelphia, PA (US)

(72) Inventors: Andrew King, Philadelphia, PA (US); Insup Lee, Newtown, PA (US)

(73) Assignee: THE TRUSTEES OF THE UNIVERSITY OF PENNSYLVANIA, Philadelphia, PA (US)

(21) Appl. No.: 14/452,155

(22) Filed: Aug. 5, 2014

Related U.S. Application Data
(60) Provisional application No. 61/862,404, filed on Aug. 5, 2013.

(51) Int. Cl. H04L 12/24; H04L 12/911

(52) U.S. Cl. CPC H04L 41/0816; H04L 47/70
USPC 709/221

(57) ABSTRACT

The subject matter described herein includes methods, systems, and computer readable media for enabling real-time guarantees in publish-subscribe middleware with dynamically reconfigurable networks. One exemplary method includes providing a publish-subscribe middleware interface usable by publishers and subscribers to request quality of service guarantees for data delivery across a network. The method also includes providing a global resource manager for receiving quality of service requests from the subscribers, for evaluating the requests, and for dynamically reconfiguring network resources to provide the requested quality of service guarantees.

### PRIORITY CLAIM

This application claims the benefit of U.S. Provisional Application Ser. No. 61/862,404, filed Aug. 5, 2013, the disclosure of which is incorporated herein by reference in its entirety.

### GOVERNMENT INTEREST

This presently disclosed subject matter was made with U.S. Government support under Grant No. CNS-1035715 awarded by the National Science Foundation. Thus, the U.S. Government has certain rights in the presently disclosed subject matter.

### TECHNICAL FIELD

The subject matter described herein relates to middleware for real time open systems. More particularly, the subject matter described herein relates to methods, systems, and computer readable media for enabling real-time guarantees in publish-subscribe middleware using dynamically reconfigurable networks.

### BACKGROUND

In real-time and open systems, such as monitoring systems in a hospital or a power grid, modules are plugged into the system and moved at run time. One goal when a new module is plugged into a system is that the module may need to be able to deliver data in a fixed amount of time. Some middleware standards allow applications to request quality of service. However, there is no mechanism in the middleware to guarantee such quality of service.

Another example of message based quality of service is differentiated service in IP networks where quality of service parameters can be inserted by applications in IP headers. However, there is no guarantee how routers in the network will treat packets marked with such quality of service parameters.

Another issue that exists with open networks where an application can specify its own quality of service is that bad actors can disrupt network quality of service provided to other actors. For example, an application infected with a virus could specify high quality of service for all of its packets, which may result in service degradation for other applications in the network.

In light of these difficulties, there exists a need for improved enabling of real time guarantees in publish-subscribe middleware using dynamically reconfigurable networks.

### SUMMARY

The subject matter described herein includes methods, systems, and computer readable media for enabling real-time guarantees in publish-subscribe middleware with dynamically reconfigurable networks. One exemplary method includes providing a publish-subscribe middleware interface usable by publishers and subscribers to request quality of service guarantees for data delivery across a network. The method also includes providing a global resource manager for receiving quality of service requests from the subscribers, for evaluating the requests, and for dynamically reconfiguring network resources to provide the requested quality of service guarantees.

The subject matter described herein for enabling real-time guarantees in publish-subscribe middleware using dynamically reconfigurable networks may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating a real-time publisher and a real-time subscriber with quality of service guarantees according to an embodiment of the subject matter described herein;

FIG. 2 is a flow chart illustrating admission control in a system that implements a real-time message bus according to an embodiment of the subject matter described herein;

FIG. 3 is a network diagram illustrating an exemplary deployment of the real-time message bus on an OpenFlow enabled network according to an embodiment of the subject matter described herein;

FIG. 4 is a block diagram illustrating a real-time message bus software stack according to an embodiment of the subject matter described herein;

FIG. 5 is a diagram illustrating an exemplary client API in Java according to an embodiment of the subject matter described herein;

FIG. 6 is a diagram illustrating a switch model in XML and an example network graph according to an embodiment of the subject matter described herein;

FIG. 7 is a diagram illustrating a test bench configuration according to an embodiment of the subject matter described herein;

FIG. 8 is a graph illustrating observed latency for best effort and real-time message bus traffic according to an embodiment of the subject matter described herein; and

FIG. 9 is a graph illustrating observed latency bounds for a subscriber S_{T}_{₃} to topic T₃ when publishers P_{T}_{₁} and P_{T}_{₂} to topics T₁ and T₂ are malfunctioning.

### DETAILED DESCRIPTION

### 1 Introduction & Motivation

Publish-subscribe middleware provides a simple communications abstraction for nodes in a distributed system. Nodes communicating via the publish-subscribe pattern generally take on one of two roles: that of a publisher or that of a subscriber. Publishers communicate to other nodes by publishing data to an abstract, shared namespace called a topic. Subscribers can elect to receive data by subscribing to topics. Publish-subscribe middleware confers a number of benefits for distributed systems. First, the communications abstraction leads to a loose coupling between publishers and subscribers. Second, the middleware allows for a separation of concerns: application developers do not need to concern themselves with low-level systems and communications details.

Increasingly, publish-subscribe middleware is being used in distributed real-time systems. Because real-time systems must exhibit predictable timing behavior, modern publish-subscribe middleware such as implementations of the Data, Distribution Service (DDS) specification [12], expose a Quality of Service (QoS) API that application developers can use specify various timing constraints.

Notably absent from the DDS specification is the notion of guarantees; while publishers and subscribers can specify timing constraints, the middleware is not under any obligation to ensure or enforce those timing requirements. The lack of timing guarantees in the DDS standard (and its implementations) is likely due to the fact that achieving predictable timing in a distributed real-time system is challenging: the timing behavior of a distributed system is not just a function of the application code and middleware software stack; it also depends on the underlying network and network load. Currently available publish-subscribe middleware implementations have limited or no ability to affect the configuration of the underlying network. This means that a developer of a distributed real-time system must carefully configure the network offline and a priori to ensure that no critical timing constraints will be violated for the lifetime of that system. The consequence of this limitation is that the advantages of publish-subscribe, mainly loose coupling and the separation of concerns, are diminished because real-time constraints force application developers to deal with low-level system wide issues.

If networking hardware could be managed at a low-level by the middleware itself, then the middleware could automatically provide end-to-end timing guarantees by applying schedulability analysis, admission control, and transparent network reconfiguration. Recent trends in networking make this a realistic possibility. The increasing availability of OpenFlow [11] enabled switches and routers means that commodity networking equipment could be combined with publish-subscribe middleware to create open and dynamic distributed real-time systems. This leaves a number of technical and research questions: First, what QoS parameters are needed to support strong real-time guarantees? Second, how do we architect a publish-subscribe middleware system that has complete control of the network? Third, how can we (re)configure the network using the primitives provided by OpenFlow to ensure that requested QoS is enforced?

To address these and other issues, the subject matter described herein includes a Real-Time Message Bus (RTMB), our publish-subscribe middleware prototype which is integrated with OpenFlow to provide real-time end-to-end guarantees. In Section 2 we examine the DDS QoS API, explain its current limitations and propose new QoS parameters to support end-to-end timing guarantees. In Section 3, we give a high level description of how our approach leverages OpenFlow to provide real-time guarantees. In Section 4 we describe the design of the RTMB. In Section 5 we describe algorithms which the RTMB prototype uses to perform schedulability analysis (admission control) and reconfigure the network. In Section 6 we provide the results of an experimental evaluation of the RTMB using real OpenFlow hardware. In Section 7 we describe related work. We conclude and provide some directions for future research in Section 8.

### 2 Quality of Service Proposal

The DDS standard currently exposes a number of parameters publishers or subscribers can set that can impact the timing behavior of the system. The first QoS parameter we will describe is deadline. The deadline (ddln) parameter can be set by publishers or subscribers and defines the maximum interval of time between two consecutive updates of a topic. If a publisher specifies a deadline of dₚ, then it is declaring that it will not delay more than dₚ time units between each publication event. If a subscriber specifies a deadline of dₛ then the subscriber is declaring that it expects to receive consecutive updates to the topic no longer than dₛ time units apart. While the DDS standard requires that the middleware check if publishers or subscribers are mismatched (i.e., it will notify a subscriber if it requests a dₛ<dₚ) the standard does not require any mechanism for enforcement; instead the middleware must notify the subscriber after the deadline has been violated.

The second parameter impacting end-to-end timing is latency budget (lb). Latency budget indicates the maximum acceptable latency of messages forwarded between the particular publisher or subscriber. This parameter can be set on both publishers and subscribers. Note that setting the latency budget does not result in any sort of guarantee. The standard describes it as a hint to the underlying middleware for network transport optimization purposes. For example, a publisher can use the latency budget parameter to determine how messages are batched prior to network transmission.

The third parameter directly relating to timing is transport priority (transp prior). Transport priority lets publishers assign numerical priorities to messages sent to a topic. When queuing messages for transmission in the publisher's software stack, the underlying middleware will use the priority parameter to determine which message will be serviced (i.e., transmitted or forwarded to clients) first. Applications developers typically use transport priority for one of two purposes. First, transport priority can be used to specify relative importance. For example, a higher priority can be assigned to messages with higher criticality, such as alarm messages. Second, transport priority can be assigned according to fixed priority scheduling techniques to provide message timing guarantees [6].

The first two parameters (deadline and latency budget) have limited usefulness for real-time systems because they are not associated with a notion of a guarantee. For example, say some publisher P is publishing to topic T with a declared deadline d₁. Some subscriber S comes online and requests a subscription to T with a deadline d₂. If d₂≧d₁, then the middleware will deem S and P compatible and admit the subscription. Now say that the network is continually loaded enough that updates from P to S are delayed longer than d₂. S's deadline QoS setting will be in constant violation which means that the application of S will continually be in an exceptional state.

The third parameter, transport priority, is problematic because it exposes lower level systems issues to functional applications code. The result of this is two-fold. First, it makes publishers less portable. The appropriate transport priority setting in one deployment environment may be entirely inappropriate in another. Second, it forces applications developers to deal with low-level and system wide issues. For example, applications developers not only have to worry about how any transport priority they set impacts their own application, but also how it affects all applications sharing the same network. This negates the main benefit of publish-subscribe middleware, which is that applications developers should not have to worry about whole system issues.

### 2.1 Proposed Real-Time QoS

We propose that at minimum, real-time publish-subscribe middleware should allow subscribers to specify maximum end-to-end network latency bounds. The middleware should then provide guarantees that all received messages will conform to the latency bounds, or if guarantees cannot be made, notify the subscriber at subscription time. We now formally define network latency and latency guarantees.

### Definition 1 (Network Latency)

Let P_{T} be a publisher publishing to topic T and S_{T} be a subscriber to T. Let t₁ be the moment P_{T} starts transmitting message m on the network and let t₂ be the smallest time t after m has been fully received by S_{T}. The end-to-end network latency of m is L(S_{T},m)=t₂−t₁.

### Definition 2 (Guaranteed Maximum Latency)

Let P_{T} be a publisher publishing to topic T and S_{T} be a subscriber to T. If S_{T} requests a guaranteed maximum latency, denoted Lₘₐₓ(S_{T}), then ∀ₘL(S_{T},m)≦Lₘₐₓ (S_{T}).

In addition to maximum latency, publishers must also specify the minimum separation time between consecutive messages. While minimum separation is usually not useful from an application's perspective, the middleware's scheduling algorithms will need it to calculate worst-case network loads and ultimately provide real-time guarantees.

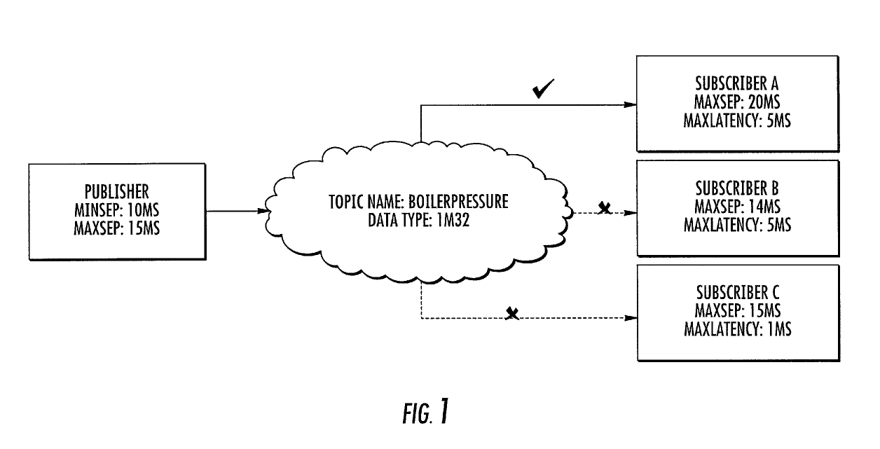

We illustrate the real-time QoS settings available in our middleware prototype in FIG. 1. We provide three different real-time QoS settings: maxSep—the maximum separation between two messages, minSep—the minimum separation between two messages, and maxLatency the maximum delay the network is allowed to incur on the delivery of the message. FIG. 1 also provides an example of how the RTMB will match QoS between publishers, subscribers, and the underlying system. Subscriber A is admitted to the system because its required maxSep (20 ms) is greater than or equal to the publishers (15 ms). Additionally the middleware has determined it can guarantee the requested maximum latency. Subscriber B is not admitted because it requires a maxSep of 14 ms which is smaller than the publisher's. Finally, Subscriber C is not admitted to the system only because the underlying middleware has determined that it cannot guarantee C's requested maximum end-to-end latency.

### 3 Approach Overview

We achieve real-time guarantees on open networks built from COTS equipment by handing complete control over the network to the middleware via OpenFlow [11]. Tight integration of the middleware with OpenFlow provides several benefits. First, it gives the middleware complete control over how data packets on the network are forwarded, prioritized, and rate-limited. Second, many consumer off the shelf (COTS) switches can be made OpenFlow capable with a firmware update. This means that existing network deployments can be made OpenFlow capable. Third, in many OpenFlow switches all OpenFlow rule processing occurs at line rate. This means that the middleware can affect configuration changes in the network without any appreciable loss of network performance.

We now describe the operation of an OpenFlow network. An OpenFlow network consists of two types of entities: OpenFlow switches and OpenFlow controllers. An OpenFlow hardware switch is a Layer 2/3 Ethernet switch that maintains a table of flow entries and actions.

### Definition 3 (Flow)

Let a flow f be a tuple (S,D) where S is a network address of the flow source, and D is the network address of the destination. S(D).

TABLE 1
Example OpenFlow flow table

| | Datalink | | | | IP | | TCP | | |
|---|---|---|---|---|---|---|---|---|---|
| Input Port | VLAN ID | Src | Dst | Type | Src | Dst | Src Port | Dst Port | Action |
| 3 | 0 | 89ab | 89ac | IP | 192.168.1.1 | 192.168.1.2 | 100 | 101 | meter = 1, enqueue = 4:7 |
| 4 | 0 | 89ac | 89ab | IP | 192.168.1.2 | 192.168.1.1 | 101 | 100 | meter = 2, enqueue = 3:2 |

The flow table associates each flow with an action set which tells the switch how to handle a packet matching the flow. Table 1 shows an example flow table. The table has two flow entries which match against input port, Ethernet address, IP address and TCP port number. There are two actions associated with each flow. While the OpenFlow specification describes a number of different actions our prototype utilizes the enqueue and meter actions. The meter action requires the switch to apply traffic policing to the flow. The enqueue action requires the switch to place the packet on an egress queue associated with a specific port during forwarding.

When an OpenFlow switch receives a packet on one of its interfaces, it compares that packet to its flow table. If the packet matches a flow table entry, it applies the action set associated with that flow entry. If the packet does not match an existing entry the switch performs what the OpenFlow protocol calls a packet-in. When the switch performs a packet-in, it forwards the packet to the OpenFlow controller (a piece software running on a server in the network). The controller analyzes the packet and can execute any arbitrary algorithm to generate a new flow rule. The controller can then update the switch's flow table with the new rule. Packet-in allows the OpenFlow controller to learn the topology of the network (i.e., learn what ports on what switches different hosts are connected to) and then effect complex routing, forwarding and QoS strategies with algorithms implemented in a normal high level programming language like Java or C++.

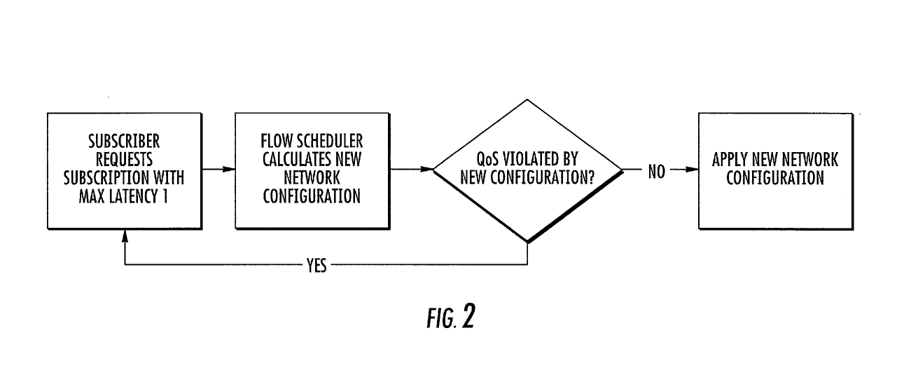

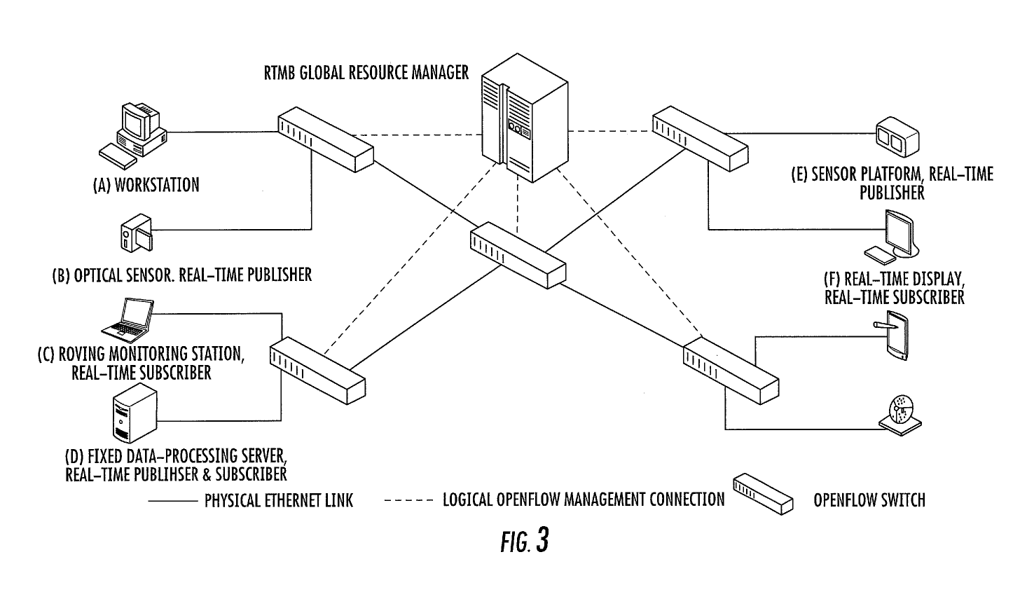

We now provide an overview of how the RTMB provides real-time guarantees on OpenFlow enabled COTS networks. The RTMB implements a Global Resource Manager (GRM) which contains a specialized OpenFlow controller (FIG. 3). When a publish-subscribe client comes online it first connects to the GRM. This allows the GRM to learn where on the network the client is located (i.e., the switch and port it is connected to). Then, when a client requests a subscription with a specified QoS, the GRM will perform admission control (FIG. 2). First, the scheduling algorithm in the GRM will generate a new network configuration based on the new QoS request. The new configuration is then analyzed by a schedulability test which determines if any QoS constraints could be violated with that configuration (see Section 5 for an example scheduling and schedulability algorithm). If a violation is possible, the client is notified and their request is not granted. If QoS is guaranteed in the new configuration, the GRM commits the network configuration to the network using OpenFlow and then admits the client. Note that this system architecture allows us to handle non publish-subscribe best effort traffic (e.g., web-browsing) on the same network transparently; the GRM can map best-effort traffic to the lowest priority queues on each switch.

### 4 Middleware Design

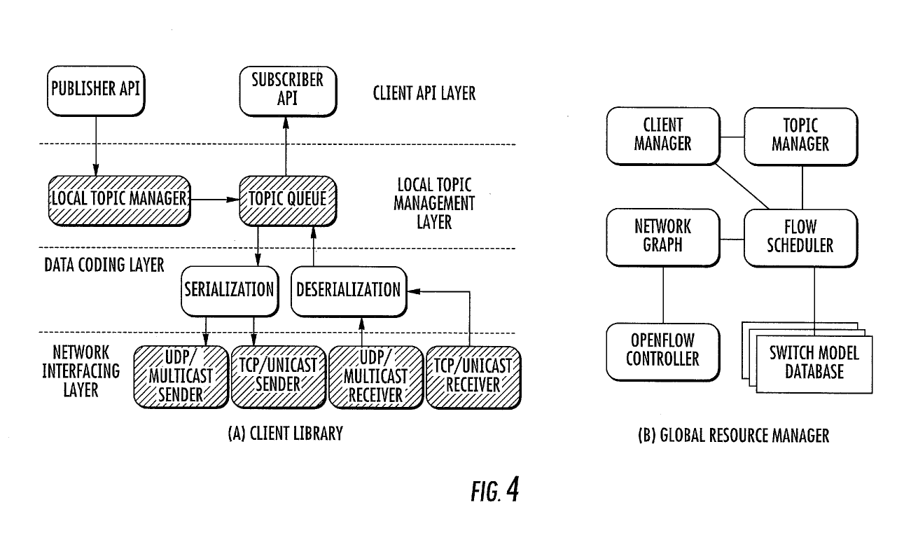

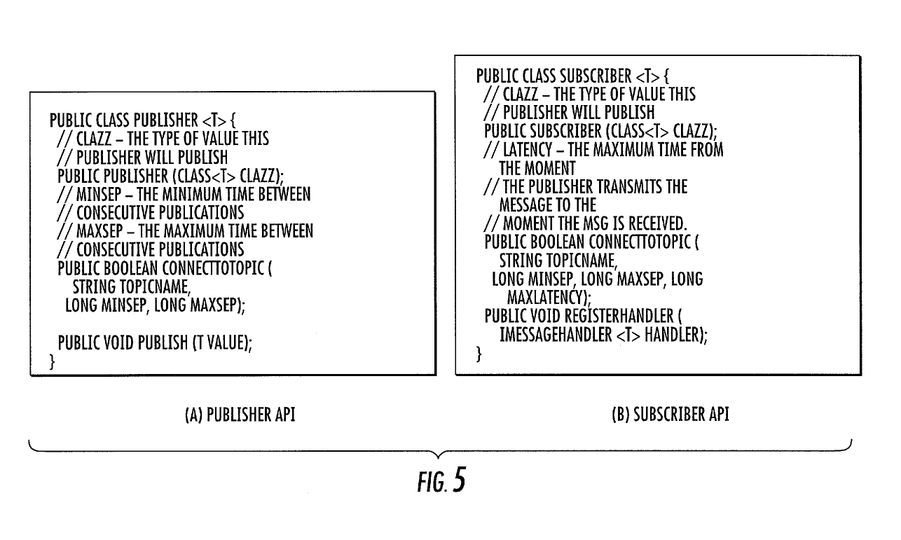

Now we describe the various software components in the RTMB. The RTMB adopts a brokerless architecture and the functionality of middleware is separated into two software stacks implemented in Java (see FIG. 4). The client library provides the publish-subscribe abstraction (FIG. 5) to clients that wish to be publishers or subscribers. The client library runs on machines that host applications that desire to be publishers or subscribers. The Global Resource Manager (GRM) runs on a server connected to the network and is responsible for managing active topics) publishers, subscribers and the underlying network configuration. Both the client library and GRM have features specifically designed to enable automatic QoS guarantees.

### 4.1 Client Library

The architecture of the client library is illustrated in FIG. 4a. If the application is a publisher, messages flow from the application to a local topic queue by way of the local topic manager. This allows the client library to perform a zero-copy transfer of data between publishers and subscriber that are running on the same host. Each local topic queue always has a special subscriber: the data-coding layer. The data-coding layer is responsible for serializing messages prior to transmission on the network. After a message has been serialized, a sender object transmits it onto the network. The type of sender used depends on what transport protocol was negotiated with the GRM. Symmetrically, the receivers receive messages from the network, pass those messages to the data coding layer where they are deserialized and then placed on the appropriate topic queue. Subscribers are invoked when the topic queue associated with their topic becomes non-empty.

The Client Library has one important feature used to support automatic QoS guarantees: it statically infers the maximum serialized message sizes from message types. When a publisher comes online it specifies the type of message it will publish. The API passes this information to the topic management layer, which in turn asks the data coding layer for message size bounds on that type. In our prototype, the data coding layer uses Java reflection to determine the structure of the type and infer the maximum number of bytes used to represent a message of that type on the network. Maximum message size information is used by the GRM when it performs the schedulability analysis of a network configuration.

### 4.2 Global Resource Manager

The GRM (FIG. 4b) is responsible for orchestrating all activity on the network to ensure that data is correctly propagated between publishers and subscribers. To accomplish this, the GRM must maintain configuration information about the network and implement the appropriate scheduling and network reconfiguration algorithms. Because we are concerned with providing guaranteed timing, the GRM must keep record of how switches in the network are interconnected, where clients are plugged into the network, the performance characteristics of each switch, and which multicast addresses are associated with what topics.

These various responsibilities are decomposed along module boundaries. Several of these modules' functions do not need to be extensively elaborated: the client manager is a server process that handles client's requests (e.g., to start publishing on a topic); and the topic manager maintains a record of active topics and the network addresses associated with each topic, the OpenFlow controller implements the OpenFlow protocol and exposes a simple API to the flow scheduler to reconfigure the network.

The flow scheduler implements the admission control, scheduling and network reconfiguration algorithms used to ensure QoS constraints are not violated (see Section 5).

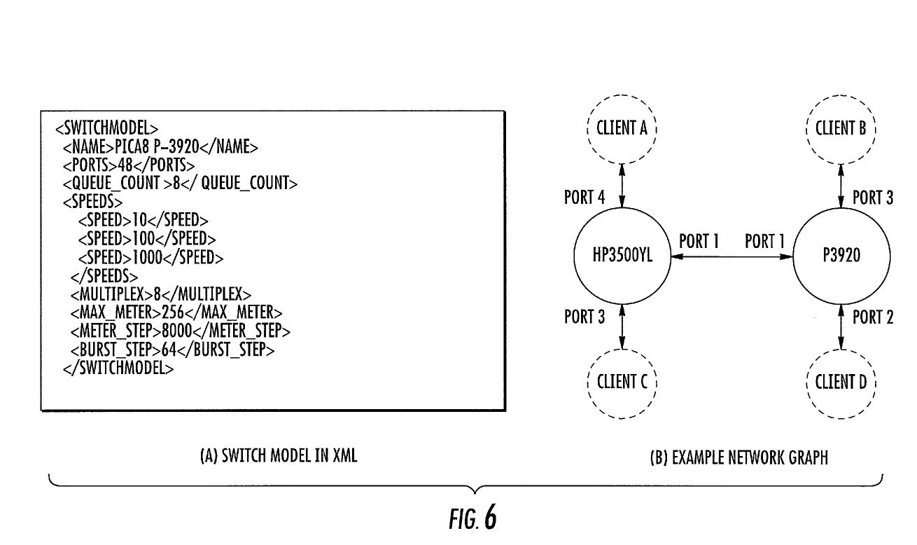

We now elaborate the network graph and the switch model data in more detail. The switch model database is a repository of performance and timing characteristics for different models of OpenFlow switch. This information is vitally important to the GRM; it needs to know how each switch in its network behaves. The information in the switch model repository is created before the middleware is deployed on a network. In our prototype each switch model is represented by an XML file that is read by the GRM when the GRM starts up. FIG. 6a contains an example switch model. Each switch model contains the model name of the switch, the number of ports on the switch, the number of egress queues associated with each port, the bandwidth capacity, and the number and precision of the hardware rate-limiters.

The network graph maintains both static and dynamic network configuration information. The static information is specified at deployment time; it defines what switches are on the network (the model, etc.) and how they interconnect. The dynamic information is either learned via OpenFlow (e.g., what ports on which switch are specific client connected) or set by the flow scheduler.

FIG. 6b illustrates a simple network graph. The network consists of two switches. These switches are connected via an uplink cable on each of their port 1. Each switch is connected to two clients (denoted by dotted circles).

### 5 Flow Scheduling

In this section we describe the schedulability and network configuration/reconfiguration algorithms we implemented in our prototype to enable guaranteed end-to-end latency. Our high-level approach is illustrated in FIG. 2. When a subscriber comes online it requests a subscription with a guaranteed maximum latency. The flow scheduler executes a scheduling algorithm which generates a candidate network configuration. The flow scheduler then analyzes the candidate configuration with a schedulability test. The schedulability test calculates an upper bound on the worst case latencies that any subscriber in the system may experience with the new configuration. If the new configuration might cause a violation of any timing constraint, then the new subscriber is not admitted with its requested QoS. If the new configuration guarantees all QoS constraints, the network's current configuration is carefully transformed into the new configuration and the new subscriber is then admitted.

In general, these types of distributed real-time scheduling problems are NP-Hard if we desire optimal scheduling. Distributed scheduling for various types of systems and task/flow models have been studied extensively in the literature. We do not claim new results in terms of algorithmic speedup or optimality. Instead, we focus on illustrating how existing scheduling techniques can be adapted to work with the configuration primitives provided by OpenFlow enabled switches. In order to simplify our explanation, we first describe how our schedulability and network configuration algorithms work for a distributed system based on a network with one switch. After the basic technique has been established, we generalize the technique to the multi-switch case.

### 5.1 Single Switch Scheduling

The flow scheduler generates a candidate network configuration in several phases. First, for each publish-subscribe relationship the flow scheduler queries the OpenFlow controller to determine what switch port each publisher and is connected to and the network address associated with a given topic. Then, for each publisher P publishing to T, the flow scheduler configures a rate-limiter. The rate-limiter is configured with a maximum burst size B and maximum rate R, and is set to apply to all packets that enter the switch on the port connected to P destined to the network address associated with T, If a publisher specifies a minimum separation between each message of minSep, and maximum message size of M, then the burst size B and rate R are set as follows:

$$B = M , R = \frac{M}{minSep}$$

This allows to burst its entire message onto the network while ensuring that P cannot overload the network if P babbling idiot.

Before we can describe how the flow scheduler prioritizes flows we need to explain how to calculate upper bounds on the worst case latency of message. Latency in a switched network has a number of sources. The first is due to the bandwidth of the network link. The second is due to the physical wire that connects a network node to a switch: an electrical signal takes time to propagate along a wire (in most networks the latency effects of the wires are small because they are relatively short). The third is the multiplexing latency of the switch. Switch multiplexing latency is the time it takes a switch to move a bit entering the switch on one port to the output queue of another. On modern non-blocking switches this is usually on the order of several microseconds. Finally, there is queuing latency, which is the amount of time a message spends waiting in an egress queue. In a modern switched Ethernet all these latencies are fixed (i.e., do not change due to network load) except for queuing latency. Messages placed from different flows placed on queues associated with the same switch port are in contention for shared “forwarding resources.” We now formally define the fixed latency, queuing latency, and end-to-end latency for a single switch.

### Definition 4 (Wire Latency)

The function w(N₁, N₂) denotes the signal propagation latency between network stations N₁ and N₂. A network station can be either a switch, or a publisher/subscriber.

### Definition 5 (Fixed Latency)

Let f=(T_{T},S_{T}). Let the maximum message size of a message publish to topic T be M. Then the fixed portion of the end-to-end latency, denoted L_{F}(P_{T},S_{T}), between P_{T} and S_{T} is:

$${ℒ}_{F} ( {𝒫}_{𝒯} , {S}_{𝒯} ) = \frac{M}{C} + w ( {𝒫}_{𝒯} , s ) + w ( {S}_{𝒯} , s ) + {s}^{mux} \qquad ( 1 )$$

where C is the network bandwidth and s^{mux} is the multiplexing latency of switch s.

### Definition 6 (Queuing Latency)

Let (P_{T},S_{T}) be the flow from P_{T} to S_{T}, and let s(i) be the i^{th} port on switch s which the flow is routed out of, then the queuing latency of the flow (P_{T},S_{T}) with priority p at switch/port s(i) is Q(P_{T},S_{T},s(i),p).

### Definition 7 (End-to-End Latency)

The end-to-end latency Lₑ₂ₑ is the sum of the fixed and queuing latency:

Lₑ₂ₑ(P_{T},S_{T})=L_{F}(P_{T},S_{T})+Q(P_{T},S_{T},s(i),p) (2)

How can we calculate Q(P_{T},S_{T},s(i),p)? We adapt an approximate technique for calculating the response time of a task under fixed priority scheduling on a uniprocessor. In [5], Bini et al. provide a linear equation for calculating an upperbound worst; case response time of a task. Assuming Pᵢ is the minimum separation between consecutive arrivals of task Tᵢ, Eᵢ is the worst case execution time and hp (i) is the set of tasks assigned priority higher than Tᵢ then the response time Rᵢ is bounded from above by:

$${R}_{i}^{ub} = \frac{{E}_{i} + {\sum }_{j ∈ hp ( i )}^{ } {E}_{j} ( 1 - \frac{{E}_{j}}{{P}_{j}} )}{1 - {\sum }_{j ∈ hp ( i )}^{ } \frac{{E}_{j}}{{P}_{j}}} \qquad ( 3 )$$

This equation is useful in our application because the per-task workload approximations Bini et al. used to derive the response time bound also approximate the traffic pattern of a flow conforming to a rate-limiter. We then to transform Equation 4 into a worst-case bound on latency due to queuing we by substituting the correct terms and subtracting the overall message transmission cost for our flow (Let hp (p,s (i)) be the set of flows with priority higher than p at port s(i)):

$${Q ( {𝒫}_{𝒯} , {S}_{𝒯} , s ( i ) , p )}^{ub} = \frac{\frac{{M}_{𝒯}}{C} + {\sum }_{j ∈ hp ( p , s ( i ) )}^{ } \frac{{M}_{j}}{C} ( 1 - \frac{\frac{{B}_{j}}{C}}{{minSep}_{j}} )}{1 - {\sum }_{j ∈ hp ( p , s ( i ) )}^{ } \frac{\frac{{B}_{j}}{C}}{{minSep}_{j}}} - \frac{{M}_{𝒯}}{C} \qquad ( 4 )$$

We can now use the upper-bound on worst-case switch latency to determine how to prioritize each flow. Common techniques for priority assignment in real-time systems include the Rate Monotonic (RM) and Deadline Monotonic orderings (DM) [3]. Unfortunately, both RM and DM theory require that each flow is assigned a unique priority. This is not possible on real networking hardware: most Ethernet switches only provide 8 priority queues per port for egress traffic. To overcome this limitation, we use Audsley's Optimal Priority Assignment. (OPA) algorithm [2]. OPA has two desirable properties: It is optimal (if a flow set will meet its latency requirement under any fixed-priority configuration it will also under OPA) and it minimizes the number or priority levels required to schedule the Row set. Because each port of the switch is independent in terms of its egress queuing, we only need to differentiate the priorities of flows exiting the switch on the same port.

We now describe a version of Audsley's OPA adapted to assign priorities to flows in an OpenFlow switch (Algorithm 1). Our modified OPA takes as input a set of flows (denoted F) forwarded out of the same port. OPA starts by attempting to assign flows to the lowest priority level. If a flow f can exceed its latency bounds at a given priority level, OPA moves on and will attempt to assign that flow a higher priority later. Conservatively, a flow(P_{T},S_{T}) can miss its latency bounds if Q(P_{T},S_{T},s(i),p)^{ub}+L_{F} (P_{T},S_{T})>Lₘₐₓ(S_{T}). If OPA exits before assigning a priority to every flow) then the flow set; is not schedulable with any fixed priority assignment. If the number of priority levels required to schedule F is greater than the number of priorities provided by the switch, then the flow scheduler deems the flow set unschedulable.

Algorithm 1 Audsley's Optimal Priority Assignment

1: procedure OPA (F)
2: for i = 1 → n do
3: unassigned ← true
4: while F ≠ Ø do
5: Select some flow f ∈ F
6: F′ ← F − f (F′is the set of all flows other than f)
7: hp(f) ← F′(assume all flows in F′are assigned a higher priority)
8: if Q(M_{f},i,p′)^{ub} ≦ Lₘₐₓ(f) − fixedDelays then
9: assign flow f to priority level i
10: F ← F′
11: unassigned ← false
12: end if
13: if unassigned then
14: Exit because no feasible assignment exists
15: end if
16: end while
17: end for
18: end procedure

Before admitting a new subscriber the flow scheduler must carefully commit the new configuration to the network; if new flows are added to the network the priority assignments of existing flows may change. These flows must be migrated to their new priorities in a specific order to avoid priority inversions. To safely accomplish the reconfiguration the flow scheduler maps existing priorities according to their priority assignment in the new configuration: flows with lower priority are reprioritized first.

Algorithm 2 Safe priority Reconfiguration

| | |
|---|---|
| 1: | procedure RECONFIGURE (M) |

| | |
|---|---|
| 2: | Let L be the list of flow- to- priority mappings in M in reverse |
| | priority order |
| 3: | for (f,p) ∈ L do |

| | |
|---|---|
| 4: | SetPriority(f,p) |

| | |
|---|---|
| 5: | end for |

| | |
|---|---|
| 6: | end procedure |

### 5.2 Extension to Multi-Switch

The prototype flow scheduler supports real-time guarantees on networks consisting of multiple switches by transforming the distributed scheduling problem into a sequence of local (i.e., single switch) scheduling problems. Before we proceed we modify Equations 5 and 2 to describe the sources of latency for a flow that is forwarded through a sequence of switches. As in the single switch case there are fixed and queuing sources of latency:

### Definition 8 (Multiswitch Fixed Latency)

Let p be a path of length m through the network from P_{T} to S_{T}, Let Nₖ be the k^{th} network node (switch or publisher/subscriber) on ρ. Let the maximum message size of a message publish to topic T be M. Then the fixed portion of the end-to-end latency, denoted L_{F}^{ρ}(P_{T},S_{T}), between P_{T} and S_{T} is:

$${ℒ}_{F}^{ρ} ( {𝒫}_{𝒯} , {S}_{𝒯} ) = \frac{M}{C} + {\sum }_{1 < k \leq m}^{ } w ( {N}_{k - 1} , {N}_{k} ) + {\sum }_{1 < k < m}^{ } {s}_{k}^{mux} \qquad ( 5 )$$

### Definition 9 (Multiswitch Queuing Latency Latency)

Let ρ be a path through the network with length m from P_{T} to S_{T}. Then the queuing latency due to all the switches on ρ is the sum of all the queuing latencies of the switches along the path:

$${Q}^{ρ} ( {𝒫}_{𝒯} , {S}_{𝒯} ) = {\sum }_{1 < k < m}^{ } Q ( {𝒫}_{𝒯} , {S}_{𝒯} , {s}_{k} ( i ) , {p}_{k} ) \qquad ( 6 )$$

### Definition 10 (Total Multiswitch End-to-End Latency)

Let ρ be a path through the network crossing m switches. Then the total end-to-end latency due to both fixed and queuing delays along p is:

Lₑ₂ₑ^{ρ}(P_{T},S_{T})=Q^{ρ}(P_{T},S_{T})+L_{F}^{ρ}(P_{T},S_{T}) (7)

Given these equations for end-to-end latency for flows crossing multiple switches we describe how the RTMB generates and applies network configurations for multi-switch networks. As mentioned earlier in this section distributed scheduling is in general quite difficult. Further complicating matters is that the RTMB must be able to reconfigure the entire network without causing any QoS constraint violations for existing flows. This is challenging because the reconfiguration of an upstream switch will impact the worst case load on downstream switches. Imagine for example a simple network consisting of two switches s₁ and s₂. Now imagine some flow f forwarded along the path s₁, s₂. Say that the minimum separation between bursts of f at s₁ is 20 ms and the worst case queuing latency at s₁ is 3 ms. This means that the minimum separation that could be observed by s₂ is 17 ms (the case where the first burst of f is delayed the maximum amount and then the second burst is not delayed at all). Now assume a new flow f′ is admitted to the network and it is prioritized higher than f on s₁. This will increase the worst-case queuing latency of f (e.g., to 10 ms) at s₁ and further contract the worst-case burst separation observed by s₂ (down to 10 ms).

We avoid having to calculate network-wide side effects each time a new subscriber is admitted by transforming the distributed scheduling problem into a sequence of local scheduling problems: When a subscriber S_{T} requests a subscription to T with a latency constraint Lₘₐₓ(S_{T}) we first calculate the shortest unweighted path ρ between P_{T} and S_{T}. Next, we uniformly allot a portion Lₘₐₓ(S_{T}) to each switch: for each switch sₖ in ρ “ve calculate Lₘₐₓ(S_{T})sₖ where:

$${{ℒ}_{max} ( {S}_{𝒯} )}_{{s}_{k}} = \frac{{ℒ}_{max} ( {S}_{𝒯} ) - {ℒ}_{F}^{ρ} ( {𝒫}_{𝒯} , {S}_{𝒯} )}{\vert ρ \vert}$$

That is, we split the allowed queuing latency up evenly between all the switches along p. We now recursively calculate the worst case minimum separation observed at each switch on the path. Let minSepₖ be the minimum worst case separation of bursts at switch sₖ then:

minSepₖ₊₁=minSepₖ−Lₘₐₓ(S_{T})ₛ_{ₖ}

Finally, we apply the single switch schedulability, priority assignment and network reconfiguration algorithms using each Lₘₐₓ(S_{T})sₖ and minSepₖ for the appropriate switch. Because we fixed the allotted switch queuing latency when the flow as admitted, the minSepₖ values will never change.

### 6 Experimental Evaluation

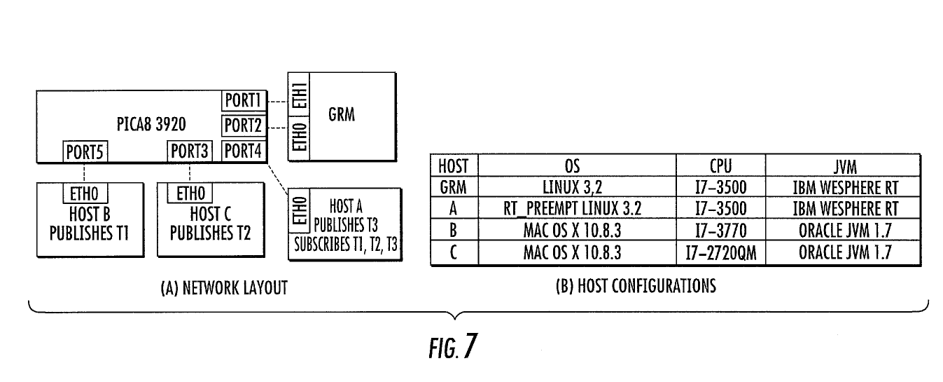

We evaluated two aspects of the RTMB. First we wanted to see if the network scheduling used in the RTMB improved the timing performance relative to that of a standard switch. Second, we wanted to see how robust the RTMB timing guarantees are. In order to evaluate these two aspects we deployed the RTMB on our OpenFlow test bench (FIG. 7a).

Our OpenFlow test-bench consists of 4 computers (FIG. 7b) and an OpenFlow capable switch, a Pica8 P3290 [1]. Each of the 4 computers were plugged into the switches' data-plane ports (i.e., OpenFlow managed ports). The GRM was also plugged into the control-plane port which carries OpenFlow management traffic. Measuring end-to-end timing in a distributed network accurately is challenging due to clock synchronization issues. We avoid these synchronization issues by exploiting OpenFlow to let us run publishers and subscribers on the same hosts: we add an OpenFlow rule that causes the switch to intercept packets from certain flows, rewrite the packet headers, and then retransmit the packet back out the port it arrived on. This allows us to ‘fool’ the client; it can publish to Tₓ and subscribe to T_{y} but in reality it the messages being published to Tₓ are being sent back modified so they look as if they are from T_{y}. This allows us to compare the timestamps of messages using the same system clock while still subjecting the message to the same queuing, multiplexing and wire latencies it would experience if it was being sent to another host.

All timing measurements we done on Host A. Host A was running real-time Linux with IBM's RTSJ-compliant Real-Time JVM. The RTMB client library on Host A was scheduled with the highest system priority using RTSJ Java's NoHeapRealtimeThreads to ensure that they would not be interfered with by the Java garbage collector or other processes on the system. All timing measurements were made by calling Java's System.currentTimeMillis( ). Prior to running our experimental scenarios, we lower-bounded the amount of latency added by the Linux TCP/IP stack and the JWM by sending a message to the loopback interface. This latency was consistently 1 ms.

For each experiment we used the same 3 publishers each publishing to a different topic (T₁, T₂ and T₃) with a single host subscribing to each topic. Table 2 lists each topic, relevant QoS (minSep from the publisher and max latency from the subscriber), and the bandwidth required by each. For each experiment we captured all messages received within a 10 second window and recorded their latencies.

TABLE 2
Experimental Publish-Subcribe Set

| | | | Message | |
|---|---|---|---|---|
| Topic | minSep | Max. Latency | Size (Bytes) | Bandwidth |
| T₁ | 3 ms | 2 ms | 192192 | 512.512 mbit/s |
| T₂ | 3 ms | 3 ms | 96000 | 256.000 mbit/s |
| T₃ | 11 ms | 8 ms | 64000 | 46.545 mbit/s |
| TOTAL: | | | | 815.057 mbit/s |

### 6.1 Scenario 1: Comparison to Best-Effort

Here we compare the performance of the middleware in two network settings. In the first setting, we configure the Ethernet switch to behave like a normal L2/L3 switch. We call this the ‘best-effort’ setting. In the second setting we place the network under control of the RTMB as described herein. We observed the end-to-end latencies of messages published to T₂ while the network was also handling subscriptions to T₁ and T₃.

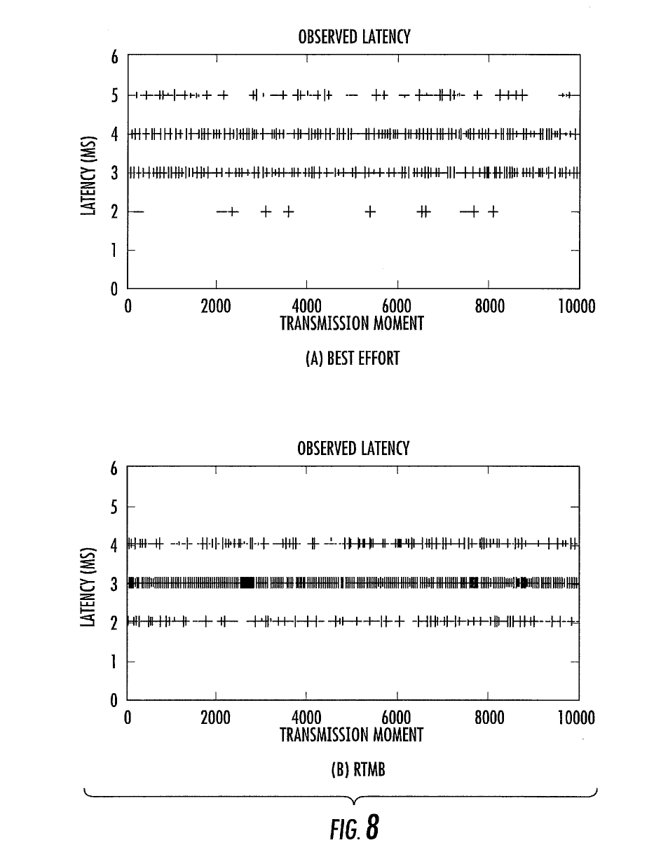

The results of this observation are presented in FIG. 8. Each point on each graph represents the end-to-end latency of a single message sent to T₂ and received by the subscriber. The x-axis is the moment (in milliseconds) that the message was transmitted. The y-axis is the latency of that message. Even accounting for jitters in the operating system and JVM the end-to-end deadline of S_{T}_{₂} is occasionally violated on the best-effort system. Taking into account platform jitters, no messages violated the latency requirement when the RTMB was managing the network configuration. What is not obvious from the graph is the number of messages of T₂ that are lost in the best effort system: S_{T}_{₂} never received 48% of the messages that were sent. All messages arrived in the RTMB-managed setting.

### 6.2 Scenario 2: Fault Containment

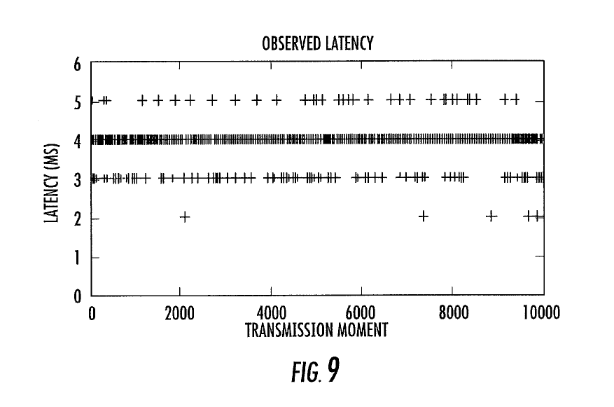

In this scenario we modify the publishers to T₁ and T₂ so they transmit as fast as they can and we record the latencies of messages flowing to T₃. In this experiment the publishers were able to saturate a 1 gigabit per second Ethernet link each. We modified P_{T}_{₁} and P_{T}_{₂} because the RTrvIB will configure their respective flows with the highest priority which means they have the most opportunity to steal resources from the other flows if they misbehave. When run on the best effort network (i.e., with no flow prioritization) P_{T}_{₁} and P_{T}_{₂} were able to starve enough of the network forwarding capacity from the flow associated with P_{T}_{₃} to cause all messages to be dropped. FIG. 9 contains the observed latencies when the RTMB was managing the network. Again, each point in the graph represents a single message. The y-axis is latency of that message, and its x-value is the moment the message was transmitted. Under the RTMB, no messages were dropped and all messages arrived earlier than their required latency bounds, 8 ms.

### 7 Related Work

To our knowledge the RTMB is the first example of a publish-subscribe middleware that uses OpenFlow to provide real-time guarantees on COTS Ethernet networks. Most research into middleware for distributed real-time systems can be divided into two categories. The first category involves research into how various CPU scheduling and determinism features can be used in middleware to effectively support the predictable execution of distributed tasks in a distributed environment. Examples of such work include TAO [15] and the many middleware other real-time Corba [14] middleware works such as FC-ORB[16], QuO [17] and [8].

The other, less extensively studied, category includes middleware which tries to achieve deterministic network behavior by coordinating the activity of the application nodes. Examples of such work are [10], FTT-Ethernet [13] and the Synchronous Scheduling Service for RMI [4]. These approaches all offer some notion of guarantee but they are not robust because they depend on the cooperation of each node on the network: if a node does not cooperate (either due to a fault or malicious activity) then that node can disrupt the whole network.

There have also been a number of projects where OpenFlow has been used to provide some type of QoS guarantee. However, these projects have not focused on real-time systems aspects. Instead, their application focus has been on data center centric QoS (like minimum guaranteed bandwidth) [9] or for multimedia systems [7].

### 8 Conclusion

The work described herein represents a promising step towards publish-subscribe middleware that, can automatically provide real-time guarantees. We have described a weakness of current publish-subscribe middleware for real-time systems: they do not provide end-to-end timing guarantees. We proposed that QoS settings should be associated with a notion of a guarantee. We then described the Real-Time Message Bus, a prototype publish-subscribe middleware which uses OpenFlow to manage the underlying network and provide guarantees for real-time QoS. To our knowledge, this is the first time middleware has been combined with OpenFlow for this purpose. We described both the RTMB's design and the algorithms it uses to generate network configurations that provide real-time guarantees.

Our initial evaluations showed that our prototype does enable more deterministic timing behavior. Even with a relatively high network load of 815 megabits per second all publish-subscribe network flows satisfied their millisecond-level timing requirements while on the normal Ethernet network latency constraints were violated and almost half the messages were dropped. The evaluations also showed that the RTMB's ability- to provide guarantees is robust: when we reconfigured two publishers to attempt the saturate the network the RTMB prevented the remaining flow from deviating from its specified QoS constraints.

We believe the results described herein encourage further research into OpenFlow and how it can be used to benefit real-time publish-subscribe middleware. Such research topics include better scheduling and reconfiguration algorithms designed for use with the OpenFlow primitives, other types of QoS (beyond timing) that could benefit from full network control, and ways to detect and adapt to network faults dynamically.

The subject matter described herein may be used in a variety of application areas. For example, in the healthcare area, alarm aggregation systems in hospitals function by propagating device alarms from monitors at the patient's bedside to a central location for monitoring. Current systems require a separate network infrastructure for alarm traffic to guarantee that the alarms arrive on time. This is a costly capital investment for hospitals. The subject matter described herein, including the global resource manager and the publish-subscribe middleware interface, will allow critical traffic and normal traffic to share the same network. For example, critical applications, such as patient vital sign monitors may function as publishers who contact the global resource manager for guaranteed quality of service for communication of their measurements to a monitoring or processing station, and the global resource manager may dynamically reconfigure the network to provide the requested QoS guarantee. Additionally, the subject matter described herein may facilitate a plug in play network that would automatically adapt to clinical needs. For example, when a new monitor is attached to a patient's bedside, the new monitor could become a publisher that contacts the global resource manager to receive guaranteed quality of service for communication of its measurements to a monitoring station. The global resource manager may grant or deny the request and, if the request is granted, dynamically reconfigure the network to provide the guaranteed quality of service.

Another application area for the subject matter described herein is finance. Financial trading platforms have real-time constraints. Trades must be executed at certain times and within certain time windows to maximize value. The publish-subscribe middleware interface and the global resource manager described herein will allow finance applications to use the publish-subscribe middleware interface to request minimum latency for better trades.

Another application area for the subject matter described herein is power grids. Power grids are becoming more automated. In power grids, sensors feed information over a network into algorithms, which alter how the power network distributes electricity. These algorithms have real-time constraints in order to maintain the stability of the power distribution network. The publish-subscribe middleware interface and the global resource manager described herein can streamline the addition and removal of sensors, actuators, and control algorithms that manage power grid. For example, a sensor added to the power grid could request, via the publish-subscribe middleware interface, a quality of service guarantee for its measurements. The global resource manager could either grant or deny the request and dynamically reconfigure the network to meet the quality of service guarantee of the sensor if the request is granted.

Yet another application area of the subject matter described herein is real time cloud computing. Cloud computing is increasingly used due to its elasticity in resource provisioning. Many future large scale distributed time critical applications will be based on cloud computing with real-time communication guarantees. The subject matter described herein may be used by distributed computing resources to request quality of service guarantees for communications between the computing elements. The global resource manager may be used to dynamically reconfigure the network to provide the quality of service guarantees.

The publish-subscribe middleware interface and the global resource manager when respectively executed on a computing platform transform the computing platform into a special purpose device that performs either the function of enabling publishers and subscribers to request quality of service guarantees (in the case of a client that uses the middleware interface) or in the case of the global resource manager, granting or denying those requests and dynamically reconfiguring the network to ensure guarantees for granted requests. Thus, the publish-subscribe middleware interface and the global resource manager improve the functionality of computer networks and of applications that use those networks. Technological fields such as high speed networks and applications that use such networks will be improved. It should also be noted that the computing platforms on which the publish-subscribe middleware interface and the global resource manager execute may be special purpose computing platforms themselves even without the publish-subscribe middleware interface or the global resource manager. For example, as described above, the publish-subscribe middleware interface may execute on a patient vital sign monitor or a power grid sensor, each of which may be considered a special purpose computing platform. The global resource manager may execute on a server that also functions as an Openflow controller, and such as server map also be considered a special purpose computing platform.

The disclosure of each of the following references is hereby incorporated by reference in its entirety.

### REFERENCES

1. Pica8 3290 Product Literature (2013), http://www.hp.com/rnd/products/switches/HP_ProCurve_Switch_{—}5400 z1_{—}3500 yl_Series/specs.htm
2. Audsley, N., Dd, Y.: Optimal priority assignment and feasibility of static priority tasks with arbitrary start times (1991)
3. Audsley, N. C.: Deadline monotonic scheduling (1990)
4. Basanta-Val, P., Almeida, L., Garcia-Valls, M., Estevez-Ayres, I.: Towards a synchronous scheduling service on top of a unicast distributed real-time java. In: Real Time and Embedded Technology and Applications Symposium, 2007. RTAS'07. 13th IEEE. pp. 123-132. IEEE (2007)
5. Bini, E., Nguyen, T. H. C., Richard, P., Baruah, S.: A response-time bound in fixed-priority scheduling with arbitrary deadlines. Computers, IEEE Transactions on 58(2), 279-286 (February 2009)
6. Dipippo, L. C., Wolfe, V. F., Esibov, L., Bethmangalkar, G. C. R., Bethmangalkar, R., Johnston, R, Thuraisingham, B., Mauer, J.: Scheduling and priority mapping for static real-time middleware. Real-Time Syst. 20(2), 155-182 (March 2001), http://dx.doi.org/10.1023/A:1008189804392
7. Egilmez, H. E., Dane, S. T., Bagci, K. T., Tekalp, A. M.: Openqos: An openflow controller design for multimedia delivery with end-to-end quality of service over software-defined networks. In: Signal & Information Processing Association Annual Summit and Conference (APSIPA ASC), 2012 Asia-Pacific. pp. 1-8. IEEE (2012)
8. Eide, E., Stack, T., Regehr, J., Lepreau, J.: Dynamic cpu management for realtime, middleware-based systems. In: Real-Time and Embedded Technology and Applications Symposium, 2004. Proceedings. RTAS 2004. 10th IEEE. pp. 286-295. IEEE (2004)
9. Kim, W., Sharma, P., Lee, J., Banerjee, S., Tourrilhes, J., Lee, S. J., Yalagandula, P.: Automated and scalable qos control for network convergence. Proc. INM/WREN 10, 1-1 (2010)
10. Marau, R, Almeida, L., Sousa, M., Pedreires, P.: A middleware to support dynamic reconfiguration of real-time networks. In: Emerging Technologies and Factory Automation (ETFA), 2010 IEEE Conference on. pp. 1-10 (September)
11. McKeown, N., Anderson, T., Balakrishnan, H., Parulkar, G., Peterson, L., Rexford, I., Shenker, S., Turner, J.: Openflow: enabling innovation in campus networks. SIGCOMM Comput. Commun. Rev. 38(2), 69”-74 (March 2008), http://doi.acm.org/10.1145/1355734.1355746
12. Pardo-Castellote, G.: Omg data-distribution service: architectural overview. In: Distributed Computing Systems Workshops, 2003. Proceedings. 23rd International Conference on. pp. 200-206 (May)
13. Pedreiras, P., Gai, P., Almeida, L., Buttazzo, G. G.: Ftt-ethernet: a flexible realtime communication protocol that supports dynamic qos management on Ethernet-based systems. Industrial Information, IEEE Transactions on 1(3), 162-172 (2005)
14. Schmidt, D., Kuhns, F.: An overview of the real-time corba specification. Computer 33(6), 56-63 (2000)
15. Schmidt, D. C., Levine, D. L., Mungee, S.: The design of the tao real-time object request broker. Comput. Commun. 21(4), 294-324 (April 1998), http://dx.doLi.org/10.1016/S0140-3664(97)00165-5
16. Wang, X., Chen, Y., Lu, C., Koutsoukos, X.: Fc-orb: A robust distributed real-time embedded middleware with end-to-end utilization control. Journal of Systems and Software 80(7), 938-950 (2007)
17. Zinky, J. A., Bakken, D. E., Schantz, R. E.: Architectural support for quality of service for corba objects. Theory and Practice of Object Systems 3(1), 55-73 (1997)

It will be understood that various details of the subject matter described herein may be changed without departing from the scope of the subject matter described herein. Furthermore, the foregoing description is for the purpose of illustration only, and not for the purpose of limitation.

What is claimed is:

1. A method for enabling real-time guarantees in publish-subscribe middleware with dynamically reconfigurable networks, the method comprising:
providing a publish-subscribe middleware interface usable by publishers and subscribers to request quality of service guarantees for data delivery across a network; and
providing a global resource manager for receiving quality of service requests from the subscribers, for evaluating the requests, and for dynamically reconfiguring network resources to provide the requested quality of service guarantees.

2. The method of claim 1 wherein providing a publish-subscribe middleware interface includes providing an interface through which publishers and subscribers can request timing guarantees for data delivery across the network and wherein providing a global resource manager includes providing a global resource manager adapted to dynamically configure the network to meet the timing guarantees.

3. The method of claim 1 wherein providing a global resource manager includes providing a global resource manager including an OpenFlow controller for dynamically reconfiguring the network resources in response to the requests.

4. The method of claim 1 wherein the publish-subscribe middleware interface is usable by new publishers and subscribers to an open network to join and leave the network in real time while the network is operational and have quality of service guarantees on communications between the publishers and subscribers.

5. The method of claim 1 wherein the global resource manager is adapted to dynamically reconfigure network resources with rate limiters to limit communications involved in a time critical transmission when a client becomes faulty and begins consuming more resources than initially requested via the publish-subscribe middleware interface.

6. The method of claim 1 wherein the publish-subscribe middleware interface and the global resource manager allow best effort traffic to transparently share the network with time critical traffic by automatically mapping best effort traffic to a lower priority than time critical traffic.

7. The method of claim 1 wherein the publish-subscribe middleware interface responds to publishers and subscribers to indicate whether or not a network configuration that will ensure the requested quality of service can be generated.

8. The method of claim 1 comprising providing at least one client that uses the publish-subscribe middleware interface to request a quality of service guarantee from the global resource manager.

9. The method of claim 8 wherein the at least one client comprises a patient vital sign monitor that functions as a publisher of patient vital sign measurements.

10. The method of claim 8 wherein the at least one client comprises a power grid sensor that publishes power grid measurements

11. The method of claim 8 wherein the client comprises a cloud computing application that uses distributed computing resources and requests a quality of service guarantee for communications between the distributed computing resources.

12. A system for enabling real-time guarantees in publish-subscribe middleware with dynamically reconfigurable networks, the system comprising:
a publish-subscribe middleware interface usable by publishers and subscribers to request quality of service guarantees for data delivery across a network; and
a global resource manager for receiving quality of service requests from the subscribers, for evaluating the requests, and for dynamically reconfiguring network resources to provide the requested quality of service guarantees.

13. The system of claim 12 wherein the publish-subscribe middleware interface is configured to allow publishers and subscribers to request timing guarantees for data delivery across the network and wherein the global resource manager is adapted to reconfigure the network resources to meet the timing guarantees.

14. The system of claim 12 wherein the global resource manager includes an OpenFlow controller for dynamically reconfiguring the network resources in response to the requests.

15. The system of claim 12 wherein the publish-subscribe middleware interface is usable by new publishers and subscribers to an open network to join and leave the network in real time while the network is operational and have quality of service guarantees on communications between the publishers and subscribers.

16. The system of claim 12 wherein the global resource manager is adapted to dynamically reconfigure network resources with rate limiters to limit communications involved in a time critical transmission when a client becomes faulty and begins consuming more resources than initially requested via the publish-subscribe middleware interface.

17. The system of claim 12 wherein the publish-subscribe middleware interface and the global resource manager allow best effort traffic to transparently share the network with time critical traffic by automatically mapping best effort traffic to a lower priority than time critical traffic.

18. The system of claim 12 wherein the publish-subscribe middleware interface responds to subscribers to indicate whether or not a network configuration that will ensure the requested quality of service can be generated.

19. The system of claim 12 comprising at least one client that uses the publish-subscribe middleware interface to request a quality of service guarantee from the global resource manager.

20. The system of claim 19 wherein the at least one client comprises a patient vital sign monitor that functions as a publisher of patient vital sign measurements.

21. The system of claim 19 wherein the at least one client comprises a power grid sensor that publishes power grid measurements

22. The system of claim 19 wherein the client comprises a cloud computing application that uses distributed computing resources and requests a quality of service guarantee for communications between the distributed computing resources.

23. A non-transitory computer readable medium having stored thereon executable instructions that when executed by the processor of a computer control the computer to perform steps comprising:
providing a publish-subscribe middleware interface usable by publishers and subscribers to request quality of service guarantees for data delivery across a network; and
providing a global resource manager for receiving quality of service requests from the subscribers, for evaluating the requests, and for dynamically reconfiguring network resources to provide the requested quality of service guarantees.
